(19) United States
(12) Patent Application Publication
(10) Pub. No.: US 2020/0290151 A1
(43) Pub. Date: Sep. 17, 2020

(54) LASER MACHINE AND LASER MACHINING METHOD

(71) Applicant: Murata Machinery, Ltd., Kyoto (JP)

(72) Inventor: Keita Matsumoto, Inuyama (JP)

(21) Appl. No.: 16/074,604

(22) PCT Filed: Dec. 26, 2016
(86) PCT No.: PCT/JP2016/088688

§ 371 Date: Aug. 1, 2018

(30) Foreign Application Priority Data
Feb. 5, 2016 (JP) 2016-020458

(51) Int. Cl. B23K 26/0622; B23K 26/38

(52) U.S. Cl. CPC B23K 26/0622; B23K 26/0648; B23K 26/38

(57) ABSTRACT

A laser machine includes a laser oscillator that generates a laser beam that irradiates a first region on a workpiece and a laser beam that irradiates a second region around the first region on the workpiece and a controller that changes an output of the laser beam that irradiates the first region and an output of the laser beam that irradiates the second region on the basis of a thickness of the workpiece so that the respective outputs vary between a period in which a piercing hole is formed in the workpiece and a period in which the workpiece is cut.

### TECHNICAL FIELD

This disclosure relates to a laser machine and a laser machining method.

### BACKGROUND

A laser machine is used to cut a workpiece in, for example, Japanese Unexamined Patent Application Publication No. 2014-18800. A process of cutting a workpiece using a laser machine includes forming a piercing hole in the workpiece and then cutting the workpiece from the piercing hole while moving the workpiece and a laser head relatively. Examples of a workpiece to be cut include thin plates, medium-thick plates, and thick plates.

When cutting a workpiece using a laser beam as described above, machining quality or machining speed may be reduced depending on the thickness of the workpiece. For example, if the output (intensity) of a laser beam is set to be suitable for a thin plate and a thick plate is cut using such a laser beam, the cutting surface wanders due to, for example, inefficient flow of an assist gas toward the lower surface of the workpiece, resulting in reductions in machining quality and cutting speed. On the other hand, if the output of a laser beam is set to be suitable for a thick plate and a piercing hole is formed in a thin plate using such a laser beam, a greater amount of spatter (melt) adheres to the workpiece surface, resulting in a reduction in machining quality.

In view of the foregoing, there is a need to provide improved machining quality and machining speed by controlling a laser beam in accordance with the thickness of a workpiece.

### SUMMARY

I thus provide:

A laser machine includes a laser oscillator that generates a laser beam that irradiates a first region on a workpiece and a laser beam that irradiates a second region around the first region on the workpiece and a controller that changes an output of the laser beam that irradiates the first region and an output of the laser beam that irradiates the second region on the basis of a thickness of the workpiece so that the respective outputs vary between a period in which a piercing hole is formed in the workpiece and a period in which the workpiece is cut.

A method of laser machining a workpiece includes generating a laser beam that irradiates a first region on the workpiece, generating a laser beam that irradiates a second region around the first region on the workpiece, and changing an output of the laser beam that irradiates the first region and an output of the laser beam that irradiates the second region on the basis of a thickness of the workpiece so that the respective outputs vary between a period in which a piercing hole is formed in the workpiece and a period in which the workpiece is cut.

The controller may increase, compared to an output of a laser beam that irradiates the second region in a period in which a piercing hole is formed in the workpiece having the first thickness, an output of a laser beam that irradiates the second region in a period in which a piercing hole is formed in the workpiece having a second thickness which is greater than a first thickness. The controller may increase the output of the laser beam that irradiates the second region in the period in which the piercing hole is formed in the workpiece having the second thickness. The controller may reduce, compared to an output of a laser beam that irradiates the first region in the period in which the piercing hole is formed in the workpiece having the second thickness, an output of a laser beam that irradiates the first region in a period in which the workpiece having the second thickness is cut. The controller may adjust a diameter of a laser beam that irradiates the workpiece so that a diameter of the piercing hole becomes equal to or greater than a cutting width over which the workpiece is cut. The laser oscillator may include a first oscillator that generates a laser beam that irradiates the first region and a second oscillator that generates a laser beam that irradiates the second region, and the controller may control an output of the first oscillator and an output of the second oscillator. The first oscillator may provide a laser beam to an inner layer of an optical fiber, and the second oscillator may provide a laser beam to an outer layer outside the inner layer of the optical fiber. The controller may control the output of the laser beam that irradiates the first region and the output of the laser beam that irradiates the second region on the basis of machining data in which machining conditions including the thickness of the workpiece are defined.

The output of the laser beam that irradiates the first region and the output of the laser beam that irradiates the second region are changed on the basis of the thickness of the workpiece so that the respective outputs vary between the period in which the piercing hole is formed and the period in which the workpiece is cut. Thus, the intensity distribution of a laser beam can be switched between a distribution suitable to form a piercing hole and a distribution suitable to cut the workpiece. As a result, the laser beam can be controlled to be suitable for the thickness or material of the workpiece, achieving improved machining quality or machining speed.

If the controller increases, compared to the output of the laser beam that irradiates the second region in the period in which the piercing hole is formed in the workpiece having the first thickness, the output of the laser beam that irradiates the second region in the period in which the piercing hole is formed in the workpiece having the second thickness which is greater than the first thickness, for example, scattering of a melt can be suppressed when machining the workpiece having the first thickness, and an assist gas can be efficiently fed toward the lower side of the workpiece when machining the workpiece having the second thickness. Thus, improved machining quality or machining speed can be achieved. If the controller increases the output of the laser beam that irradiates the second region in the period in which the piercing hole is formed in the workpiece having the second thickness, the output of the laser beam that irradiates the second region outside the first region is increased. Thus, a piercing hole can be formed with improved machining quality such that the diameter of the piercing hole is gradually increased. If the controller reduces, compared to the output of the laser beam that irradiates the first region in the period in which the piercing hole is formed in the workpiece having the second thickness, the output of the laser beam that irradiates the first region in the period in which the workpiece having the second thickness is cut, for example, outward expansion of a melt formed by the laser beam applied to the first region can be suppressed, forming a cutting line with improved machining quality. If the controller adjusts the diameter of the laser beam that irradiates the workpiece so that the diameter of the piercing hole becomes equal to or greater than the cutting width over which the workpiece is cut, for example, scattering of a melt can be suppressed when starting to cut the workpiece, achieving improved machining quality or machining speed. If the laser oscillator includes the first oscillator that generates a laser beam that irradiates the first region and the second oscillator that generates a laser beam that irradiates the second region and the controller controls the output of the first oscillator and the output of the second oscillator, the different oscillators are used with respect to the first and second regions, making it easy to control the output of the laser beam independently with respect to the first and second regions. If the first oscillator provides the laser beam to the inner layer of the optical fiber and the second oscillator provides the laser beam to the outer layer outside the inner layer of the optical fiber, the output of the laser beam applied to the first region through the inner layer of the optical fiber and the output of the laser beam applied to the second region through the outer layer of the optical fiber can be adjusted using a simple configuration. If the controller controls the output of the laser beam that irradiates the first region and the output of the laser beam that irradiates the second region on the basis of the machining data in which the machining conditions including the thickness of the workpiece are defined, for example, the output of the laser beam that irradiates the first region and the output of the laser beam that irradiates the second region can be automatically controlled, increasing productivity.

### BRIEF DESCRIPTION OF THE DRAWINGS

FIG. 1 is a conceptual drawing showing an example of a laser machine.

FIGS. 2(A) to 2(c) are conceptual drawings showing an optical path and an application region in the laser machine of the example.

FIG. 3 is a diagram showing beam modes of the laser machine.

FIGS. 4(A) and 4(B) are diagrams showing operation in thin-plate machining mode and thick-plate machining mode.

FIGS. 5(A) and 5(B) are diagrams showing the operation of an oscillator in pulse oscillation mode.

FIG. 6 is a flowchart showing a laser machining method of the example.

### DESCRIPTION OF REFERENCE SIGNS

1 . . . laser machine
7 . . . laser controller (controller)
11 . . . first oscillator
12 . . . second oscillator
13 . . . optical fiber
13a . . . inner layer
13c . . . outer layer
14 . . . optical system
AR1 . . . inner region (first region)
AR2 . . . outer region (second region)
LB1, LB2 . . . laser beam
W . . . workpiece

### DETAILED DESCRIPTION

An example will be described with reference to the drawings. In the drawings, directions are shown by an XYZ coordinate system. The vertical direction in the XYZ coordinate system is defined as a Z-direction, and the horizontal directions therein are defined as an X-direction and a Y-direction.

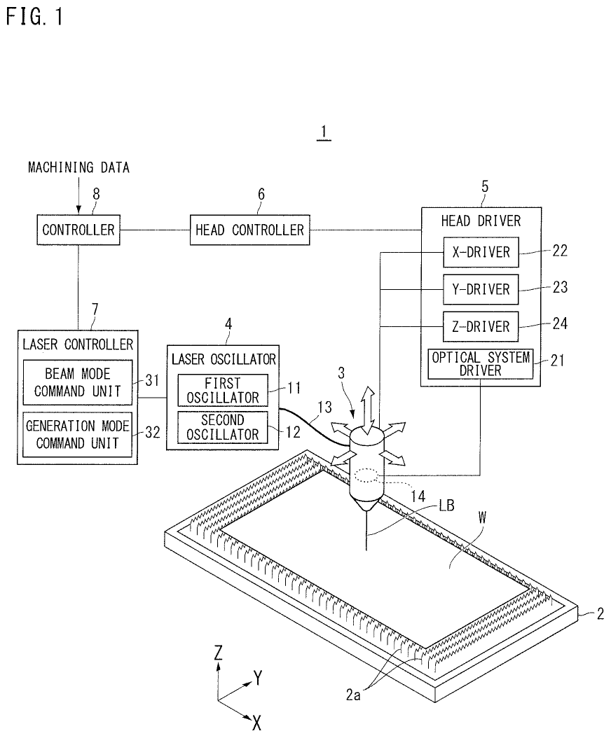

FIG. 1 is a conceptual diagram showing an example of a laser machine. A laser machine 1 is able to cut a plate-shaped workpiece W by applying a laser beam LB to the workpiece W. To cut the workpiece W, the laser machine 1 first forms a piercing hole (through hole) and then cuts the workpiece W from the piercing hole. The laser machine 1 includes a machining pallet 2, a machining head 3, a laser oscillator 4, a head driver 5, a head controller 6, a laser controller 7, and a controller 8.

The machining pallet 2 is formed, for example, by arranging multiple standing support plates 2a on a rectangular plate-shaped base. The support plates 2a are arranged in the X-direction and have sawtooth upper ends. The workpiece W is placed on the support plates 2a and supported along a horizontal plane (XY-plane). The machining pallet 2 can be moved by a driver (not shown), for example, in the X-direction.

For example, a raw workpiece W is placed on the machining pallet 2 in a position remote from the laser machining region (the region within which the machining head 3 can move); the machining pallet 2 having the workpiece W placed thereon then moves to the machining region; the workpiece W placed on the machining pallet 2 is laser-machined using the machining head 3; and the laser-machined workpiece W placed on the machining pallet 2 is transported from the machining region with the movement of the machining pallet 2. The form of the machining pallet 2 described above is illustrative only and other forms may be used. For example, instead of the saw-tooth support plates, support plates having wavy upper ends may be used. Or, the machining pallet 2 may be formed such that multiple pins are formed on a base and a workpiece W is supported by the upper ends of the pins.

The laser oscillator 4 is, for example, a fiber laser and generates a laser beam LB. The laser oscillator 4 includes a first oscillator 11 and a second oscillator 12. The laser beam LB from the laser oscillator 4 is introduced to the machining head 3 through an optical fiber 13. The machining head 3 can be located over (Z-direction) the workpiece W placed on the machining pallet 2. The machining head 3 includes an optical system 14 that condenses the laser beam LB from the laser oscillator 4 on the workpiece W. The machining head 3 applies the laser beam LB to the workpiece W through the optical system 14.

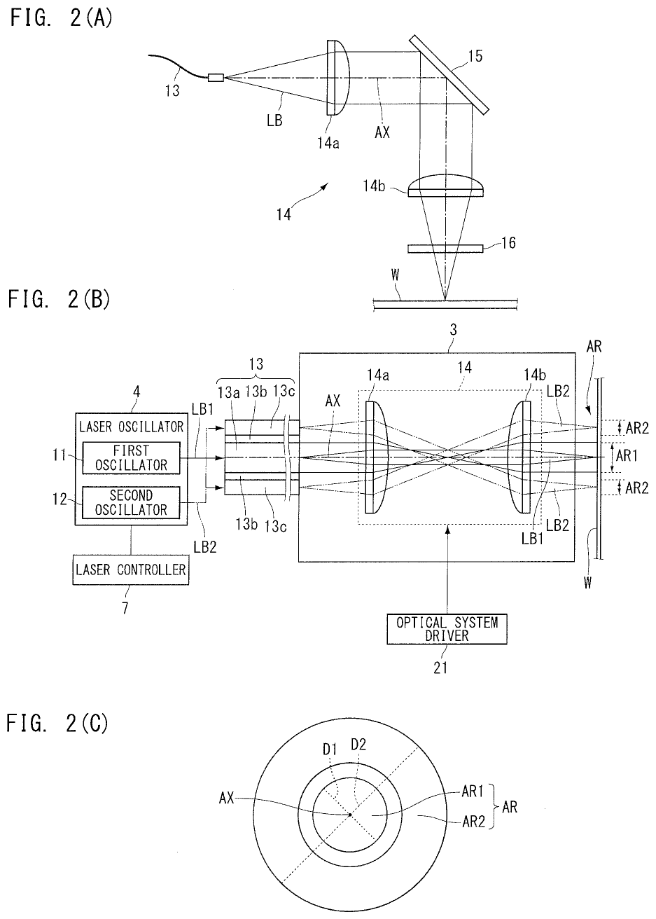

FIGS. 2(A) to 2(C) are conceptual drawings showing the optical path of the laser beam and the application region in the laser machine of the example. FIG. 2(A) shows the optical path from the optical fiber 13 to the workpiece W. FIG. 2(B) is a conceptual drawing showing the optical path from the laser oscillator 4 to the workpiece W in a linearly developed manner. The optical system 14 includes a lens 14a, a fold mirror 15, a lens 14b, and a protection glass 16 that are arranged in this order from the optical fiber 13 toward the workpiece W. The laser beam LB emitted from the optical fiber 13 is collimated by the lens 14a and then reflected by the fold mirror 15 and thus the optical path is folded. The laser beam LB is condensed by the lens 14b and then applied to the workpiece W through the protection glass 16.

As shown in FIG. 2(B), the first oscillator 11 and the second oscillator 12 generate respective laser beams. A laser beam LB1 generated by the first oscillator 11 and a laser beam LB2 generated by the second oscillator 12 have the same wavelength, but may have different wavelengths. The laser beam LB shown in FIG. 2(A) is a laser beam including one or both of the laser beam LB1 and the laser beam LB2 in FIG. 2(B).

The fiber 13 has a multilayer structure including two or more laser beam propagation layers. The optical fiber 13 includes a cylindrical inner layer 13a, an intermediate layer 13b covering the perimeter of the inner layer 13a, and an annular outer layer 13c covering the perimeter of the intermediate layer 13b. The intermediate layer 13b is a doped layer. The laser beam LB1 is reflected on the interface of the intermediate layer 13b with the inner layer 13a, and the laser beam LB2 is reflected on the interface thereof with the outer layer 13c. The laser beam LB1 from the first oscillator 11 is introduced (supplied) to the inner layer 13a, repeatedly reflected on the interface between the inner layer 13a and the intermediate layer 13b, and guided to the machining head 3 as shown in FIG. 1. The laser beam LB2 from the second oscillator 12 is introduced (supplied) to the outer layer 13c, repeatedly reflected on the interface between the outer layer 13c and the intermediate layer 13b and on the perimeter of the outer layer 13c, and guided to the machining head 3.

The laser beam LB1 and the laser beam LB2 emitted from the optical fiber 13 enter the optical system 14. The lens 14a of the optical system 14 is a collimater and collimates the laser beam LB1 and the laser beam LB2. The lens 14b of the optical system 14 is a condenser and condenses the laser beam LB1 and the laser beam LB2 from the lens 14a on the workpiece W.

FIG. 2(C) is a drawing showing a laser beam application region AR on the workpiece W. The application region AR includes a first region (hereafter referred to as inner region AR1) on the workpiece W and a second region (hereafter referred to as outer region AR2) around the first region on the workpiece W. For example, the inner region AR1 is a circular region disposed in the central portion of the application region AR, and the outer region AR2 is an annular circular region disposed around the inner region AR1. The inner region AR1 is a region corresponding to the inner layer 13a of the optical fiber 13. The laser beam LB1 from the first oscillator 11 is applied to the inner region AR1 through the inner layer 13a of the optical fiber 13. The outer region AR2 is a region corresponding to the outer layer 13c of the optical fiber 13. The laser beam LB2 from the second oscillator 12 is applied to the outer region AR2 through the outer layer 13c of the optical fiber 13.

An optical system driver 21 is able to adjust the focus position of the optical system 14. For example, the optical system driver 21 adjusts the focus position by moving at least one of the lenses included in the optical system 14 in a direction parallel with the optical axis AX of the optical system 14. The diameter D1 of the inner region AR1 and the diameter D2 of the outer region AR2 shown in FIG. 2(C) become greater as the workpiece W is located farther from the focus position of the optical system 14. If the laser beam LB1 is applied from only the first oscillator 11 of the first oscillator 11 and the second oscillator 12, the spot size of the laser beam (the laser beam LB in FIG. 1) on the workpiece W is represented by the diameter D1. In this case, the diameter of the piercing hole and the cutting width during cutting are values corresponding to the diameter D1. If the laser beam LB2 is applied from the second oscillator 12, the spot size of the laser beam on the workpiece W is represented by the diameter D2. In this case, the diameter of the piercing hole and the cutting width over which the workpiece W is cut are values corresponding to the diameter D2. The optical system driver 21 is able to change the spot size of the laser beam on the workpiece W by changing the focus position of the optical system 14. In other words, the optical system driver 21 is able to adjust the diameter of the piercing hole and the cutting width. The diameter of the piercing hole and the cutting width can be also adjusted by switching between a state in which the laser beam LB1 is applied by the first oscillator 11 and the laser beam LB2 is not applied by the second oscillator 12 and a state in which the laser beam LB2 is applied by the second oscillator 12.

Referring back to FIG. 1, the head driver 5 includes the optical system driver 21, an X-driver 22, a Y-driver 23, and a Z-driver 24. The X-driver 22, the Y-driver 23, the Z-driver 24, and the optical system driver 21 each include an actuator. The X-driver 22 moves the machining head 3 in the X-direction relative to the workpiece W. The Y-driver 23 moves the machining head 3 in the Y-direction relative to the workpiece W. The Z-driver 24 moves the machining head 3 in the Z-direction relative to the workpiece W. When forming a piercing hole in the workpiece W, the head driver 5 positions the machining head 3 relative to the workpiece W by activating the X-driver 22, the Y-driver 23, and the Z-driver 24. When cutting the workpiece W, the head driver 5 moves the machining head 3 relative to the workpiece W by activating the X-driver 22 and the Y-driver 23.

The head controller 6 controls the head driver 5 on the basis of a command from the controller 8. For example, the head controller 6 provides the target position and the target speed of the machining head 3 to the head driver 5. The X-driver 22, the Y-driver 23, and the Z-driver 24 of the head driver 5 move the machining head 3 such that the position and speed of the machining head approach the target position and target speed. Also, the head controller 6 provides the target value of the focus position of the optical system 14 to the head driver 5. The optical system driver 21 of the head driver 5 moves the lenses included in the optical system 14 so that the focus position of the optical system 14 approaches the target value.

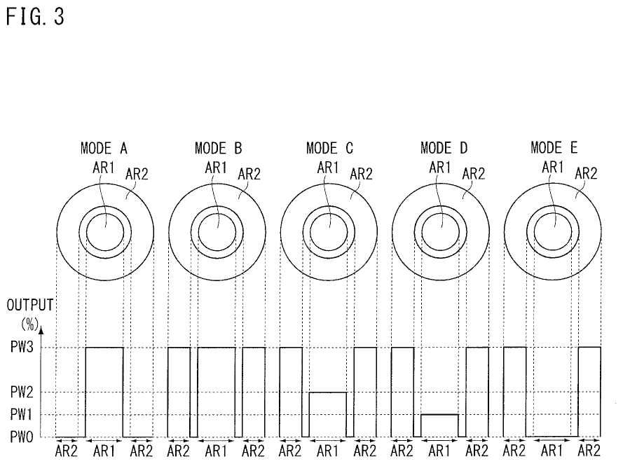

The laser controller 7 controls the laser oscillator 4. The laser controller 7 includes a beam mode command unit 31 and an oscillation mode command unit 32. The laser machine 1 has multiple beam modes as shown in FIG. 3 in which the intensity of a laser beam applied to the workpiece W shows different distributions. The beam mode command unit 31 is able to switch between the beam modes.

For example, the beam mode command unit 31 provides the target value of the output of the first oscillator 11 (the intensity of the laser beam LB1) and the target value of the output of the second oscillator 12 (the intensity of the laser beam LB2) to the laser oscillator 4 as a command to specify the beam mode. The laser oscillator 4 causes (drives) the first oscillator 11 to generate a laser beam by oscillation such that the output of the first oscillator 11 approaches the target value provided by the beam mode command unit 31. Similarly, the laser oscillator 4 causes (drives) the second oscillator 12 to generate a laser beam by oscillation so that the output of the second oscillator 12 approaches the target value provided by the beam mode command unit 31. As seen above, the beam mode command unit 31 is able to adjust the intensity distribution of the laser beam LB applied to the workpiece W by adjusting the target value of the output of each oscillator.

The oscillation mode command unit 32 controls the oscillation mode of the first oscillator 11 and the oscillation mode of the second oscillator 12. The first oscillator 11 and the second oscillator 12 are able to select the oscillation mode from pulse oscillation mode and continuous oscillation (CW) mode. The oscillation mode command unit 32 provides an oscillation mode command indicating which of pulse oscillation mode and continuous oscillation mode should be selected, to the laser oscillator 4. The laser oscillator 4 causes the first oscillator 11 and the second oscillator 12 to generate laser beams by oscillation in the oscillation mode specified by the oscillation mode command. The first oscillator 11 and the second oscillator 12 may be able to generate laser beams in only one of pulse oscillation mode and continuous oscillation mode. In this case, the oscillation mode command unit 32 can be omitted.

The controller 8 centrally controls the elements of the laser machine 1 on the basis of machining data provided from the outside. The machining data is, for example, NC data in which the machining conditions are defined. The machining conditions refer to the material and thickness of the workpiece W, the position of the cutting line, the descriptions of the steps and the like. In the machining data, the descriptions (the starting point and ending point of the cutting line, the cutting speed) of the steps are arranged in the order of the steps. The controller 8 provides commands to the head controller 6 and the laser controller 7 on the basis of the machining data. The oscillation mode command unit 32 of the laser controller 7 sets the oscillation mode of the laser oscillator 4 on the basis of the command from the controller 8.

The beam mode command unit 31 of the laser controller 7 sets the beam mode (the output of the first oscillator 11 and the output of the second oscillator 12) on the basis of the command from the controller 8 and the thickness of the workpiece W. In other words, the beam mode command unit 31 of the laser controller 7 controls the output of the first oscillator 11 and the output of the second oscillator 12 on the basis of the machining data in which the machining conditions of the workpiece W are defined. The beam mode command unit 31 sets different beam modes at the period in which a piercing hole is formed in the workpiece W (piercing hole formation) and the period in which the workpiece W is cut (cutting).

FIG. 3 is a diagram showing the beam modes. Hereafter, there will be described an example in which the beam modes are five modes consisting of mode A, mode B, mode C, mode D, and mode E. FIG. 3 shows the spatial distribution of the output (intensity) of a laser beam in the inner region AR1 and the outer region AR2. The longitudinal axis of FIG. 3 represents the ratio of the output of a laser beam to the maximum output. For example, PW0 is 0% (off state), and PW3 is 100% (maximum output). PW1 and PW2 represent outputs (a first intermediate output, a second intermediate output) greater than PW0 and smaller than PW3. PW2 is greater than PW1. For example, PW1 is 25%, and PW2 is 50%.

In mode A, the output of a laser beam in the inner region AR1 is PW3, and the output of a laser beam in the outer region AR2 is PW0. Mode B is a mode in which the output of a laser beam in the outer region AR2 is greater than that in mode A. In mode B, the output of a laser beam in the inner region AR1 is PW3, and the output of a laser beam in the outer region AR2 is also PW3. Mode C is a mode in which the output of a laser beam in the inner region AR1 is smaller than that in mode B. In mode C, the output of a laser beam in the inner region AR1 is PW2, and the output of a laser beam in the outer region AR2 is PW3. Mode D is a mode in which the output of a laser beam in the inner region AR1 is smaller than that in mode C. In mode D, the output of a laser beam in the inner region AR1 is PW1, and the output of a laser beam in the outer region AR2 is PW3. Mode E is a mode in which the output of a laser beam in the inner region AR1 is smaller than that in mode D. In mode E, the output of a laser beam in the inner region AR1 is PW0, and the output of a laser beam in the outer region AR2 is PW3.

The output of a laser beam in the inner region AR1 corresponds to the output of the first oscillator 11, and the output of a laser beam in the outer region AR2 corresponds to the output of the second oscillator 12. The beam mode command unit 31 changes the output of the first oscillator 11 and the output of the second oscillator 12 on the basis of the thickness of the workpiece W. A mode in which a workpiece having a first thickness (e.g., thin plate) is machined (thin-plate machining mode) and a mode in which a workpiece having a second thickness which is thicker than the first thickness (e.g., thick plate) is machined (thick-plate machining mode) will be described as an example below. A thin plate has a thickness of, for example, 1 mm or more and 3 mm or less, and a thick plate has a thickness of, for example, 10 mm or more or 12 mm or more.

For example, the beam mode command unit 31 determines which of thin-plate machining mode and thick-plate machining mode should be applied, on the basis of the thickness of the workpiece W included in the machining data. For example, if the thickness of the workpiece W included in the machining data is equal to or greater than a threshold, the beam mode command unit 31 determines that thick-plate machining mode should be applied. Otherwise, it determines that thin-plate machining mode should be applied. Or, if the thickness of the workpiece W included in the machining data is equal to or smaller than the threshold, the beam mode command unit 31 may determine that thin-plate machining mode should be applied. Otherwise, it may determine that thick-plate machining mode should be applied. Or, the operator may make a decision on which of thin-plate machining mode and thick-plate machining mode should be used, through the controller 8. In this case, the beam mode command unit 31 need not determine which machining mode should be used. The laser machine 1 may further have a machining mode other than thin-plate machining mode and thick-plate machining mode, for example, may have ultrathin-plate machining mode or medium-thick-plate machining mode.

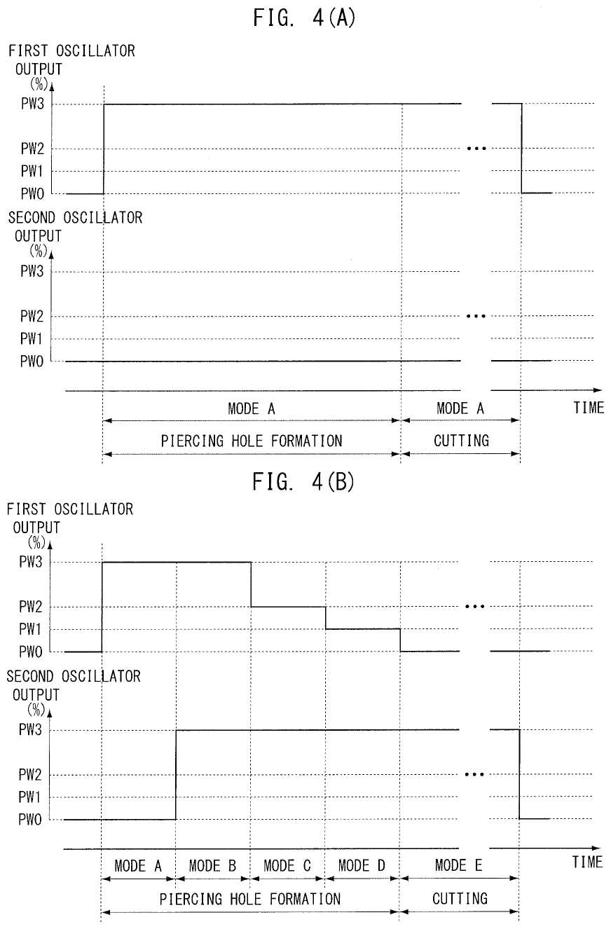

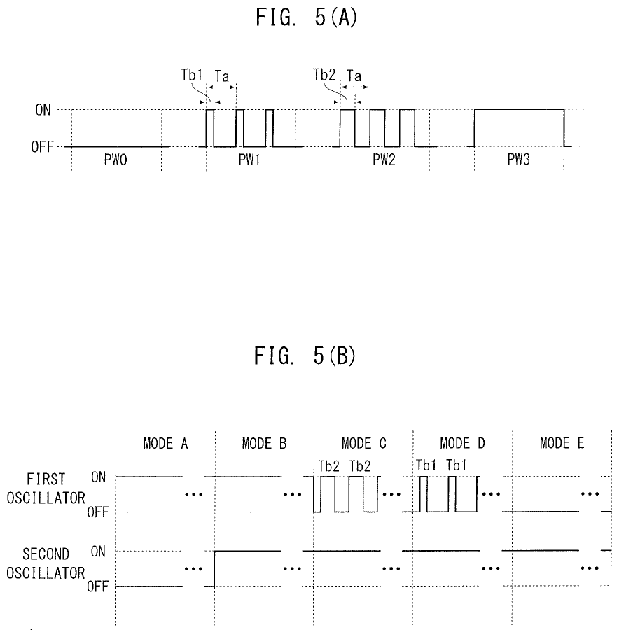

FIG. 4(A) is a diagram showing thin-plate machining mode, and FIG. 4(B) is a diagram showing thick-plate machining mode. It is assumed that continuous oscillation mode is used, and when pulse oscillation mode is used will be described with reference to FIGS. 5(A) and 5(B) later. First, thin-plate machining mode will be described. The head driver 5 positions the machining head 3 at the starting point of a cutting line (piercing hole formation position) on the workpiece W defined in the machining data under the control of the head controller 6. As shown in FIG. 4(A), the beam mode command unit 31 sets the beam mode to mode A and thus causes the first oscillator 11 to generate a laser beam LB1 having an output of PW3 to irradiate the inner region AR1. The beam mode command unit 31 also keeps the second oscillator 12 from generating a laser beam. Thus, the laser beam LB1 is applied to the inner region AR1 for a predetermined time, forming a piercing hole in the workpiece W.

In thin-plate machining mode, the diameter of a piercing hole corresponds to the spot size of a laser beam LB1 on the workpiece W. For this reason, prior to applying the laser beam LB1, the optical system driver 21 defocuses the focus position of the optical system 14 from the workpiece W under the control of the head controller 6. Thus, the spot size of the laser beam LB1 on the workpiece W is increased, and the diameter of the piercing hole is increased relative to the cutting width.

After forming the piercing hole (after the lapse of the predetermined time), the optical system driver 21 adjusts the focus position of the optical system 14 so that the spot size of the laser beam LB1 on the workpiece W matches the cutting width, under the control of the head controller 6. After adjusting the focus position of the optical system 14, the head driver 5 moves the machining head 3 so that the laser beam LB1 on the workpiece W moves along the cutting line. At this time, the beam mode command unit 31 keeps the beam mode at mode A. That is, if thin-plate machining mode is applied, the beam mode command unit 31 sets the beam mode to mode A in each of piercing hole formation and cutting.

Next, thick-plate machining mode will be described. The head driver 5 positions the machining head 3 in the piercing hole formation position. As shown in FIG. 4(B), the beam mode command unit 31 sets the beam mode to mode A and thus causes the first oscillator 11 to generate a laser beam LB1 having an output of PW3 to irradiate the inner region AR1. At the time point when the laser beam has been applied in mode A for a predetermined time, the beam mode command unit 31 sets the beam mode to mode B. Specifically, the beam mode command unit 31 causes the second oscillator 12 to generate a laser beam LB2 having an output of PW3 to irradiate the outer region AR2.

At the time point when the laser beam has been applied in mode B for a predetermined time, the beam mode command unit 31 sets the beam mode to mode C. Specifically, the beam mode command unit 31 causes the first oscillator 11 to change the output to PW2 so that a laser beam LB1 having an output of PW2 is applied to the inner region AR1. At the time point when the laser beam has been applied in mode C for a predetermined time, the beam mode command unit 31 sets the beam mode to mode D. Specifically, the beam mode command unit 31 causes the first oscillator 11 to change the output to PW1 so that a laser beam LB1 having an output of PW1 is applied to the inner region AR1. By applying the laser beam in modes A to D as described above, a piercing hole is formed.

As is obvious from a comparison between FIG. 4(A) and FIG. 4(B), the output of the second oscillator 12 is set to PW0 in the period in which a piercing hole is formed on the workpiece having the first thickness (e.g., thin plate), while the output of the second oscillator 12 is set to PW3 in the period in which the piercing hole is formed in the workpiece having the second thickness, which is greater than the first thickness (e.g., thick plate). As seen above, the controller (beam mode command unit 31) increases, compared to the output of the second oscillator 12 in the period in which a piercing hole is formed in a thin plate, the output of the second oscillator 12 in the period in which a piercing hole is formed in a thick plate.

As shown in FIG. 4(B), the output of the first oscillator 11 is set to PW3 in modes A and B, while it is set to PW2 and then PW1, that is, is reduced in modes C and D subsequent to mode B. That is, the controller (beam mode command unit 31) reduces the output of the first oscillator 11 in the period in which a piercing hole is formed in the workpiece W. While the output of the second oscillator 12 is set to PW0 in mode A, it is set to PW3 in modes B to D. That is, the controller (beam mode command unit 31) increases the output of the second oscillator 12 in the period in which a piercing hole is formed in the workpiece W.

In thick-plate machining mode, the diameter of a piercing hole corresponds to the spot size of a laser beam LB2 on the workpiece W. For this reason, prior to applying the laser beam LB2, the optical system driver 21 defocuses the focus position of the optical system 14 from the workpiece W under the control of the head controller 6. Thus, the spot size of the laser beam LB2 on the workpiece W is increased, and the diameter of the piercing hole becomes equal to or greater than the size of the cutting width.

After forming the piercing hole (after piercing hole formation), the laser machine 1 starts to cut the workpiece W. Specifically, after forming the piercing hole, the optical system driver 21 adjusts the focus position of the optical system 14 so that the spot size of the laser beam LB2 (the diameter of the outer region AR2 in FIGS. 2(B) and 2(C)) on the workpiece W matches the cutting width, under the control of the head controller 6. The beam mode command unit 31 sets the beam mode to mode E in the cutting period. Specifically, the beam mode command unit 31 causes the first oscillator 11 to change the output to PW0 so that application of the laser beam LB1 is stopped. As seen above, the controller (beam mode command unit 31) reduces, compared to the output of the first oscillator 11 in the period in which the piercing hole is formed in the workpiece W, the output of the first oscillator 11 in the period in which the workpiece W is cut. After changing the beam mode to mode E, the head driver 5 moves the machining head 3 so that the laser beam LB2 on the workpiece W moves along the cutting line.

Next, a pulse oscillation operation performed by the laser oscillator 4 will be described. FIGS. 5(A) and 5(B) are diagrams showing a pulse oscillation operation performed by the oscillator of the laser machine of the example. The first oscillator 11 and the second oscillator intermittently generate by oscillation laser beams having predetermined intensities in pulse oscillation mode. FIG. 5(A) shows the laser oscillation on/off timings corresponding to the outputs (PW0 to PW3) of the laser beams. When the output is PW3, continuous oscillation mode is used. When the output is PW1 or PW2, pulse oscillation mode is used.

When the output is set to PW0, laser oscillation is kept off. When the output is set to PW1, a pulse width Tb1 is set with respect to a pulse cycle Ta. The pulse cycle Ta is a time from the time point when a pulse rises (laser oscillation starts) to the time point when a subsequent pulse rises. The pulse width Tb1 is a time from the time point when one pulse rises to the time point when the pulse falls (laser oscillation ends). The per-unit time output of a laser beam corresponds to the ratio (duty) of the pulse width Tb1 to the pulse cycle Ta. The per-unit time output of a laser beam is increased as Tb1/Ta is increased. For example, if PW1 is 25%, Tb1/Ta may be set to 0.25. When the output is set to PW2, a pulse width Tb2 is set with respect to the pulse cycle Ta. The pulse width Tb2 is greater than the pulse width Tb1 when the output is set to PW1. For example, if PW2 is 50%, Tb1/Ta may be set to 0.5. When the output is set to PW3, the oscillator is caused to continuously generate a laser beam, and laser oscillation is kept on. Even when the output is set to PW3, the oscillator may be driven in a pulsed manner. In this case, it is only necessary to adjust the pulse widths corresponding to the respective outputs as appropriate.

FIG. 5(B) is a drawing showing operation of the first oscillator 11 and the second oscillator 12 in each beam mode. In mode A, the first oscillator 11 is set to continuous oscillation mode, and the laser oscillation of the second oscillator is kept off. In mode B, the first oscillator 11 is set to continuous oscillation mode, and the second oscillator is also set to continuous oscillation mode. In mode C, the pulse width of the first oscillator 11 is set to Tb2, and the second oscillator is set to continuous oscillation mode. In mode D, the pulse width of the first oscillator 11 is set to Tb1, and the second oscillator is set to continuous oscillation mode. In mode E, the laser oscillation of the first oscillator 11 is kept off, and the second oscillator is set to continuous oscillation mode.

Even if the first oscillator 11 and the second oscillator 12 generate laser beams in a pulsed manner as described above, piercing hole formation and cutting can be performed while changing the beam mode as shown in FIG. 4(B). Also, in pulse oscillation mode, the output of a laser beam may be changed by keeping the pulse width at a constant value through multiple beam modes and changing the pulse amplitude (intensity). Also, at least one of the first oscillator 11 and the second oscillator 12 may include multiple laser sources (e.g., multiple oscillators), and the total output of laser beams may be adjusted by changing the number of those to be turned on, of the laser sources. For example, the first oscillator 11 may include four laser sources, and the output may be made 50% by turning on two and turning off two, or the output may be made 25% by turning on one and turning off three.

In this example, the laser oscillator 4 causes the first oscillator 11 to generate a laser beam LB1 to irradiate the inner region AR1 and causes the second oscillator 12 to generate a laser beam LB2 to irradiate the outer region AR2, that is, the respective regions of the application region AR are assigned to the oscillators. However, other configurations may be employed. For example, the laser oscillator 4 may branch a laser beam generated by one oscillator, introduce one of the resulting laser beams to the inner layer 13a of the optical fiber 13, and introduce the other laser beam to the outer layer 13c thereof. To branch a laser beam, a half mirror may be used, or a diffraction grating or the like may be used. To adjust the outputs of the branched one laser beam and the other laser beam, for example, the one laser beam may be blocked using a shutter or the like. Or, a neutral filter or the like may be used to adjust the amounts of the one laser beam and the other laser beam.

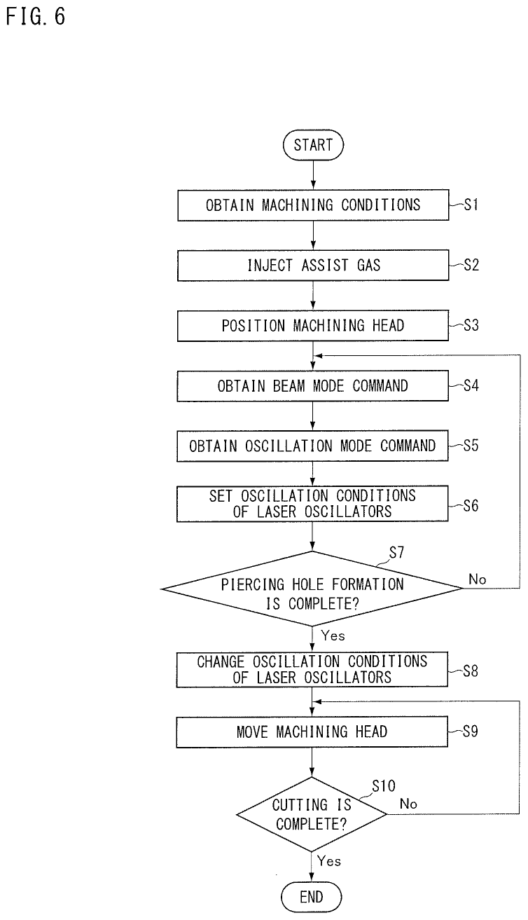

Next, a laser machining method of the example will be described on the basis of the operation of the laser machine 1 described above. FIG. 6 is a flowchart showing the laser machining method of the example. In step S1, the controller 8 obtains machining conditions. For example, the controller 8 receives machining data and obtains machining conditions defined in the machining data. In the following description, it is assumed the workpiece W is a thick plate. In step S2, the controller 8 starts to inject an assist gas. In step S3, the head driver 5 moves the machining head 3 and positions it in the piercing hole formation position under the control of the head controller 6.

In step S4, the laser oscillator 4 obtains a beam mode command that specifies the output of the first oscillator 11 and the output of the second oscillator 12. In step S5, the laser oscillator 4 obtains an oscillation mode command that specifies the oscillation mode of the first oscillator 11 and the oscillation mode of the second oscillator 12. The beam mode command is generated by the beam mode command unit 31 of the laser controller 7 in accordance with the thickness of the workpiece W and the machining stage.

In step S6, the laser oscillator 4 sets the oscillation conditions (output, oscillation mode, oscillation time) of the first oscillator 11 and the second oscillator 12. The laser oscillator 4 then causes the first oscillator 11 and the second oscillator 12 to generate laser beams in accordance with the set oscillation conditions. For example, when starting to form a piercing hole, the laser oscillator 4 causes the first oscillator 11 and the second oscillator 12 to operate in mode A shown in FIG. 4(B).

After the lapse of the oscillation time defined in the oscillation conditions, the laser oscillator 4 determines whether the piercing hole formation is complete, in step S7. If the machining in mode D shown in FIG. 4(B) is not complete, the laser oscillator 4 determines that the piercing hole formation is not complete (step S7: No) and returns to step S4 to obtain a subsequent beam mode command. For example, the beam mode command unit 31 generates a beam mode command indicating that machining should be performed in mode B subsequent to mode A, and the laser oscillator 4 obtains this beam mode command. The laser oscillator 4 repeats steps S4 to S7 and performs machining sequentially in modes A to D.

If the machining in mode D shown in FIG. 4(B) is complete, the laser oscillator 4 determines that the piercing hole formation is complete (step S7: Yes) and changes the oscillation conditions of the first oscillator 11 and the second oscillator 12 in step S8. For example, the laser oscillator 4 sets the beam mode to mode E in FIG. 4(B) and causes the first oscillator 11 to stop laser oscillation. In step S9, the head driver 5 moves the machining head 3 along the cutting line under the control of the head controller 6. If one step (e.g., cutting along one cutting line) defined in the machining data is complete, the head controller 6 determines whether the cutting is complete, in step S10. If there is a subsequent step commanded by the controller 8, the head controller 6 determines that the cutting is not complete (step S10: No) and returns to step S9 to move the machining head 3 in accordance with the subsequent step (e.g., cutting along a subsequent cutting line). If there is no subsequent step commanded by the controller 8, the head controller 6 determines that the cutting is complete (step S10: Yes) and ends the process. When the cutting is complete, the laser controller 7 causes the first oscillator 11 and the second oscillator 12 to stop the application of the laser beams, in accordance with a command from the controller 8.

While modes A to E are shown in FIG. 3 as an example of multiple beam modes, one or more of modes A to D can be omitted. While, in the example, a piercing hole is formed while changing the mode in the order of modes A to D, for example, a piercing hole may be formed in one of modes A to D. Or, one or more of modes A to D may be omitted, and a piercing hole may be formed in the remaining two or more modes. For example, mode D may be omitted, and modes A to C may be performed sequentially. Also, the workpiece W may be cut by applying a laser beam LB1 to the inner region AR1. Also, the workpiece W may be cut in mode D in place of mode E. In this case, the laser machine 1 need not have mode E. Also, the laser machine 1 may have a beam mode that differs from any of modes A to E. For example, while, in the above example, piercing hole formation is started without applying a laser beam LB2 to the outer region AR2, it may be started by applying a laser beam LB2 to the outer region AR2 in a mode where smaller output is produced than in mode B, in place of mode A. While, in the above example, the output of a laser beam is constant in each of modes A to E and is changed in stages by changing the mode from mode A to mode E, it may be changed continuously. For example, instead of modes C and D, a mode in which the output of a laser beam LB1 is continuously changed from PW3 to PW0 may be provided. Also, while, in the above description, the outputs of PW1 to PW3 are 25%, 50%, and 100%, respectively, those outputs may be set to any values of more than 0% and 100% or less.

In the above example, the laser controller 7 includes, for example, a computer system. In this case, the laser controller 7 reads a program (control program) stored in a storage device (not shown) and performs various processes in accordance with the program. This program causes the computer to generate a laser beam LB1 that irradiates the inner region AR1 on the workpiece W, to generate a laser beam LB2 that irradiates the outer region AR2 around the inner region AR1 on the workpiece W, and to change the output of the laser beam LB1 that irradiates the inner region AR1 and the output of the laser beam LB2 that irradiates the outer region AR2 on the basis of the thickness of the workpiece W so that the respective outputs vary between the period in which a piercing hole is formed in the workpiece W and the period in which the workpiece W is cut. This program may be stored in a computer-readable storage medium and provided.

The technical scope of this disclosure is not limited to the aspects described in the example or the like. One or more of the requirements described in the example or the like may be omitted. The requirements described in the example or the like can be combined with each other as necessary. The contents of Japanese Patent Application No. 2016-020458 and all documents cited in this disclosure are incorporated herein by reference.

1.-9. (canceled)

10. A laser machine comprising:
a laser oscillator that generates a laser beam that irradiates a first region on a workpiece and a laser beam that irradiates a second region around the first region on the workpiece; and
a controller that changes an output of the laser beam that irradiates the first region and an output of the laser beam that irradiates the second region on the basis of a thickness of the workpiece so that the respective outputs vary between a period in which a piercing hole is formed in the workpiece and a period in which the workpiece is cut.

11. The laser machine of claim 10, wherein the controller increases, compared to an output of a laser beam that irradiates the second region in a period in which a piercing hole is formed in the workpiece having the first thickness, an output of a laser beam that irradiates the second region in a period in which a piercing hole is formed in the workpiece having a second thickness which is greater than a first thickness.

12. The laser machine of claim 11, wherein the controller increases the output of the laser beam that irradiates the second region in the period in which the piercing hole is formed in the workpiece having the second thickness.

13. The laser machine of claim 11, wherein the controller reduces, compared to an output of a laser beam that irradiates the first region in the period in which the piercing hole is formed in the workpiece having the second thickness, an output of a laser beam that irradiates the first region in a period in which the workpiece having the second thickness is cut.

14. The laser machine of claim 10, wherein the controller adjusts a diameter of a laser beam that irradiates the workpiece so that a diameter of the piercing hole becomes equal to or greater than a cutting width over which the workpiece is cut.

15. The laser machine of claim 10, wherein
the laser oscillator comprises:
a first oscillator that generates a laser beam that irradiates the first region; and
a second oscillator that generates a laser beam that irradiates the second region, and
the controller controls an output of the first oscillator and an output of the second oscillator.

16. The laser machine of claim 15, wherein
the first oscillator provides a laser beam to an inner layer of an optical fiber, and
the second oscillator provides a laser beam to an outer layer outside the inner layer of the optical fiber.

17. The laser machine of claim 10, wherein the controller determines the output of the laser beam that irradiates the first region and the output of the laser beam that irradiates the second region on the basis of machining data in which machining conditions including the thickness of the workpiece are defined.

18. A method of laser machining a workpiece comprising:
generating a laser beam that irradiates a first region on the workpiece;
generating a laser beam that irradiates a second region around the first region on the workpiece; and
changing an output of the laser beam that irradiates the first region and an output of the laser beam that irradiates the second region on the basis of a thickness of the workpiece so that the respective outputs vary between a period in which a piercing hole is formed in the workpiece and a period in which the workpiece is cut.

19. The laser machine of claim 12, wherein the controller reduces, compared to an output of a laser beam that irradiates the first region in the period in which the piercing hole is formed in the workpiece having the second thickness, an output of a laser beam that irradiates the first region in a period in which the workpiece having the second thickness is cut.

20. The laser machine of claim 11, wherein the controller adjusts a diameter of a laser beam that irradiates the workpiece so that a diameter of the piercing hole becomes equal to or greater than a cutting width over which the workpiece is cut.

21. The laser machine of claim 12, wherein the controller adjusts a diameter of a laser beam that irradiates the workpiece so that a diameter of the piercing hole becomes equal to or greater than a cutting width over which the workpiece is cut.

22. The laser machine of claim 13, wherein the controller adjusts a diameter of a laser beam that irradiates the workpiece so that a diameter of the piercing hole becomes equal to or greater than a cutting width over which the workpiece is cut.

23. The laser machine of claim 11, wherein
the laser oscillator comprises:
a first oscillator that generates a laser beam that irradiates the first region; and
a second oscillator that generates a laser beam that irradiates the second region, and
the controller controls an output of the first oscillator and an output of the second oscillator.

24. The laser machine of claim 12, wherein
the laser oscillator comprises:
a first oscillator that generates a laser beam that irradiates the first region; and
a second oscillator that generates a laser beam that irradiates the second region, and
the controller controls an output of the first oscillator and an output of the second oscillator.

25. The laser machine of claim 13, wherein
the laser oscillator comprises:
a first oscillator that generates a laser beam that irradiates the first region; and
a second oscillator that generates a laser beam that irradiates the second region, and
the controller controls an output of the first oscillator and an output of the second oscillator.

26. The laser machine of claim 14, wherein
the laser oscillator comprises:
a first oscillator that generates a laser beam that irradiates the first region; and
a second oscillator that generates a laser beam that irradiates the second region, and
the controller controls an output of the first oscillator and an output of the second oscillator.

27. The laser machine of claim 11, wherein the controller determines the output of the laser beam that irradiates the first region and the output of the laser beam that irradiates the second region on the basis of machining data in which machining conditions including the thickness of the workpiece are defined.

28. The laser machine of claim 12, wherein the controller determines the output of the laser beam that irradiates the first region and the output of the laser beam that irradiates the second region on the basis of machining data in which machining conditions including the thickness of the workpiece are defined.

29. The laser machine of claim 13, wherein the controller determines the output of the laser beam that irradiates the first region and the output of the laser beam that irradiates the second region on the basis of machining data in which machining conditions including the thickness of the workpiece are defined.
